(19) United States
(12) Patent Application Publication
(10) Pub. No.: US 2021/0291232 A1
(43) Pub. Date: Sep. 23, 2021

(54) GO/NO-GO SIZER FOR GENERALLY SPHERICAL FRUIT, TUBERS AND VEGETABLES

(71) Applicant: Samuel Michael Grijalva, Bakersfield, CA (US)

(72) Inventor: Samuel Michael Grijalva, Bakersfield, CA (US)

(21) Appl. No.: 16/821,977

(22) Filed: Mar. 17, 2020

(51) Int. Cl. B07B 1/15; B07B 1/46

(52) U.S. Cl. CPC B07B 1/15; B07B 1/38; B07B 1/4636

(57) ABSTRACT

A go/no-go sizing device for generally spherical tubers, fruit and vegetables utilizes an inclined endless conveyor bed of rotating spindles on which multiple spools are axially mounted end-to-end so that pockets are formed between axially-aligned spools on adjacent spindles. The pockets are sized to permit undersized produce pieces to fall through the bed. Oversize pieces are collected at the top of the incline. Each of the rotating spindles has a cylindrical roller at each end thereof that can be varied in diameter to increase or decrease rotational speed of the spindles, each cylindrical roller being in contact with a stationary bump strip, which includes a series of upward ramps, each of which is followed by a vertical drop down to the next ramp, so that both rotational motion and vertical motion are imparted to each spindle as it travels across the bed.

### FIELD OF THE INVENTION

The present invention relates, generally, to sizing equipment for generally spherical tubers, fruit, and vegetables. More specifically, it relates to a go/no-go sizing device which utilizes a conveyor bed made of rotating spindles, on which multiple spools are coaxially mounted, which oscillate up and down as they convey produce up an incline. Undersized produce falls through pockets formed by spools on adjacent spindles.

### BACKGROUND OF THE INVENTION

This invention relates to a device for sorting and sizing produce. A wide variety of machines have been used to size produce such as a screen conveyor constructed with holes of a designated diameter to allow the undersized produce to fall through. The problems are the screen has a short life as the holes stretch, wear rapidly, require a shaking and bouncing to dislodge the larger produce from occupying the available holes necessary for separation. Elongated produce will not rotate to fall through if not bounced and shaken.

Several attempts have been made to remedy the situation. The Milestone screw sizer, covered by U.S. Pat. No. 3,721,345, which was granted to Scott W. Brown and Owen K. Ward, uses lateral rotating screws that have the ridges substantially aligned. The produce considered too small are supposed to fall through the open holes, as the potatoes travel or are conveyed across the deck of rotating screws.

A major problem with this arrangement is that the deck is not large enough to separate the small potatoes and to allow them time to find an unoccupied hole to fall through. The screw action shown in the patent drawing needs just seven rotations to convey from start to end. The individual screws, which all rotate which all rotate in the same direction, tend to move the potatoes to one side of the deck. This action does not separate, but bunches the potatoes to the side to flow off the deck in an unsized mass. Each screw has a long opening the length of the screw, thus the opening is not round and cannot adhere to a specific size such as a 2 inch diameter. The screws are supported with a bearing at both ends, and not cantilevered. The length of travel across the bed, while maintaining a space between the screws, cannot be increased substantially.

The rotation energy of motion of the screw is not concentrated towards the opening, but directional, as evident by the movement toward two different right angle paths. This disrupts the rotation movement necessary to align oblong potatoes to a vertical position directly on an open hole.

A traveling expanding roll sizer has rollers which expand the space between the rollers as they travel over a takeaway belt. This allows for the larger diameter produce to travel further. The problem is oval shaped produce has narrow ends and a considerably wider cross section, thus for example a round fat potato is carried farther than a long thin potato, but with a weight of much less.

A stationary spool sizer is a series of stationary shafts providing spools with rotational motion, but no forward motion. The problems here are that the holes acquire produce that is discharged neither by passing over nor falling through, thus the plugged holes soon limit the separation ability and many undersigned pieces carry over. The spools are constructed of a rubber material to which mud and rot readily adheres. The produce is often damaged because when one spool is rotating down the next is rotating up. If the down rotation spool finds a high friction surface and the up rotation spool has a low friction surface the produce is pinched, broken or squashed through the hole.

A star table is a series of rotating shafts which can be adjustable as to space between the shafts and as to rotational speed. The star is constructed of soft rubber. The produce articles are hit by the rotating stars; the large articles are lifted and the soft dirt is broken; the small articles that miss the flailing of the rubber stars will fall through the opening. The problem with a star table is that the openings between stars on adjacent shafts are essentially square rather than round. Therefore, adjusting the width between the shafts, without changing the spacing and diameter of the stars, does very little to increase the size of product falling through the table. Sizing accuracy is difficult to achieve because to the majority of produce pieces are round in shape rather than square. With such an apparatus, sizing accuracies are so poor that only about a quarter of the undersized product will fall through the table. To achieve the levitation needed one must rotate the shafts fast enough for the stars to hit the larger produce hard enough and often enough to allow the smaller size produce to slip through. In the slapping effect, even with the soft rubber stars, a slight disappearance of the skin or or other damage occurs each time the produce is struck. The effect on freshly harvested produce, such as potatoes, which are not fully matured, if slapped long and hard enough in the abrasion of dirt and sand, will remove all the skin. If the potato has a low pulp temperature such as in storage, any drop or impact will cause considerable damage, and more so as the pulp temperatures are reduced below 45 degrees F.

An electronic weight sizer or an electronic profile, although accurate, is very expensive and requires an environment not available in the field. The produce to be sized by weight or profile first has to be measured one piece at a time, thus the volumes to be separated are limited. Dirt, rocks and dust would surely damage the electronics.

U.S. Pat. No. 5,931,312, which was granted to Dennis W. Gifford, describes a sizing device constructed of includes a level conveying assembly of equally-spaced rolling spindles, on each of which are mounted a plurality of spools fabricated from an ultra-high-molecular-weight (UHMW) polyolefin thermoplastic such as polyethylene, and positioned end-to-end on the spindle. Spools on adjacent spindles form an array of pockets through which undersize fruit, tubers or vegetables can fall for collection below. Produce which does not fall through the pockets of the conveying assembly of rolling spindles is offloaded oversize produce. One of the problems associated with the Gifford sizing device is that produce that is only slightly oversize can become lodged within the pockets formed by the spools of adjacent spindles, such that it cannot fall through the pockets for collection as undersize produce or be carried to the outlet as oversize produce. The Gifford device provides no mechanism to dislodge such produce. Another problem with the Gifford sizer is that only rotational kinetic energy is imparted to the individual pieces of produce as they move along the conveying assembly of equally-spaced rolling spindles. Rotational kinetic energy can be expressed as: Eᵣₒₜₐₜᵢₒₙₐₗ=½Iω², where ω is the angular velocity and I is the moment of inertia around the axis of rotation.

### SUMMARY OF THE INVENTION

The go/no-go produce sizer of the present invention, which is designed to size generally spherical tubers, fruit, and vegetables, incorporates a conveyor bed made of rotating spindles, on which multiple spools are coaxially mounted, and which oscillate up and down as they convey produce up an incline. Undersized produce falls through pockets formed by spools on adjacent spindles. The equipment can handle a wide range of product volume throughput, which is dependent on product density, piece count per volume, and equipment belt speed. The sizer includes an inclined conveyor bed comprising an assembly of equally-spaced spindles on which are mounted a plurality of identical spools made from ultra-high-molecular-weight polyethylene (UHMWPE). Each spool has a flange at both ends. Spool flanges on adjacent spindles create pockets through which undersize generally spherical fruit or vegetables can fall onto an undersize offload chute or offload conveyor. Spools of varying size can be installed on the spindles, depending on the product being processed. Each end of each spindle is equipped with a cylindrical roller, which are affixed to the spools, and which ride on fixed bump strips located on opposite sides of the bed. As the spindles move up the incline, contact of the rollers with the bump strips cause the rollers and associated spools to rotate as a unit. In addition, each bump strip features slow-rise/rapid-fall ski bed design that incorporates a series of upwardly inclined ramps of equal length, each of which is followed by a vertical drop to the next ramp in the series. A preferred ramp length is between 100 to 150 mm. Thus, not only is rotational energy imparted to the product pieces as all spools rotate in the same direction, with the spool tops rotating toward the discharge end of the bed, but additional kinetic energy is imparted to the product pieces as the spindles are repeatedly driven up the inclined ramps, and then dropped vertically. This technique facilitates the tumbling of undersize product pieces into spindle sizing pockets, through which they fall into the undersize offload chute or conveyor. Produce, which is introduced to the conveyor bed at an in-feed end at the bottom of the incline, drops onto the rolling sizing spools. While being transported by the rolling spindle/spool assemblies, undersize product pieces tumble along the bed until they pass through the sizing pockets of the rolling spindle/spool assembles. Product pieces that are unable to pass through the sizing pockets are considered oversize pieces and are allowed to enter the product discharge at the top of the incline. Product pieces that are only slightly oversize can become intermittently lodged within a sizing pockets. These pieces are ejected, or dislodged, from the sizing pockets by the fingers of a star wheel roller located on a head roller, which push pieces stuck in pockets up and out so that they can be discharged from the bed, at the discharge end, as oversize pieces. The purpose of the inclined conveyor bed is to slow the transport of produce pieces from the in-feed end of the sizer to the discharge end thereof, thereby providing individual undersize pieces with greater opportunity to fall through pockets in the bed. Of course, if the angle of inclination is too steep, little or no progress toward the discharge end will be made. Thus, there are two competing objectives that must be balanced: produce throughput and adequate sorting of undersize and oversize pieces. An optimum angle of bed inclination will provide an acceptable throughput and adequate sorting of pieces. An optimum angle of inclination is presently deemed to be between three and six degrees.

Equipment design utilizes industry sanitary practices. The structure is made of No. 304 stainless steel, has no level surfaces, and does not utilize hollow steel tubes. Spaced-apart cogged drive belts, to which ends of the spindles are secured, utilizes a pitch within a range from 35 mm to 60 mm. Commonly available pitches within that range are 35 mm, 40 mm, 42 mm, 44 mm, 45 mm, 50 mm, 56 mm and 60 mm. The pitch is chosen as a function of product sizing diameter. Sizing spools and cylindrical rollers are machined from either white or black ultra-high-molecular-weight polyethylene (UHMWPE). UHMWPE is an impact-resistant, moisture-resistant, generally chemically-inert, low-friction thermoplastic resin. Though spool shape can vary, depending on the product being sized, the shape typically provides pockets having four points of contact, between adjacent spindle pairs, for accurate diameter sizing. The pockets are shaped to accommodate product shape anomalies somewhat larger than the desired sized diameter so that such pieces can pass through the pockets.

### BRIEF DESCRIPTION OF THE DRAWINGS

FIG. 1 is an isometric view of the go/no-go sizer for nominally spherical fruit, tubers and vegetables with the belt guards installed thereon;

FIG. 2 is an isometric view of the go/no-go sizer of FIG. 1, with the belt guards removed;

FIG. 3 is a top plan view of the go/no-go sizer of FIG. 1, with the belt guards installed thereon;

FIG. 4 is a top plan view of the go/no-go sizer of FIG. 2, with the belt guards removed;

FIG. 5 is a front elevational view of the go/no-go sizer of FIG. 1, with the belt guards installed thereon;

FIG. 6 is a front elevational view of the go/no-go sizer of FIG. 1, with the belt guards removed;

FIG. 7 is a top plan view of a go/no-go sizer, similar to that of FIG. 2, but with an extended length sorting table;

FIG. 8 is a top plan view of the go/no-go sizer of FIG. 7 with produce loaded onto the rolling spindle assembly;

FIG. 9 is an isometric view of a stationary, elevated bump strip; and

FIG. 10 is a cross-sectional view of exactly one-half of a single spindle from the sizer of FIGS. 7 and 8, taken through the spindles rotational axis by a plane perpendicular to the conveyor bed, the half spindle not shown being identical.

### PREFERRED EMBODIMENTS OF THE INVENTION

The invention will now be described in detail, with reference to the attached drawing figures. Though nearly all details of the invention are graphically identified in the first three drawings, all details of the invention will be made clear by the end of this description.

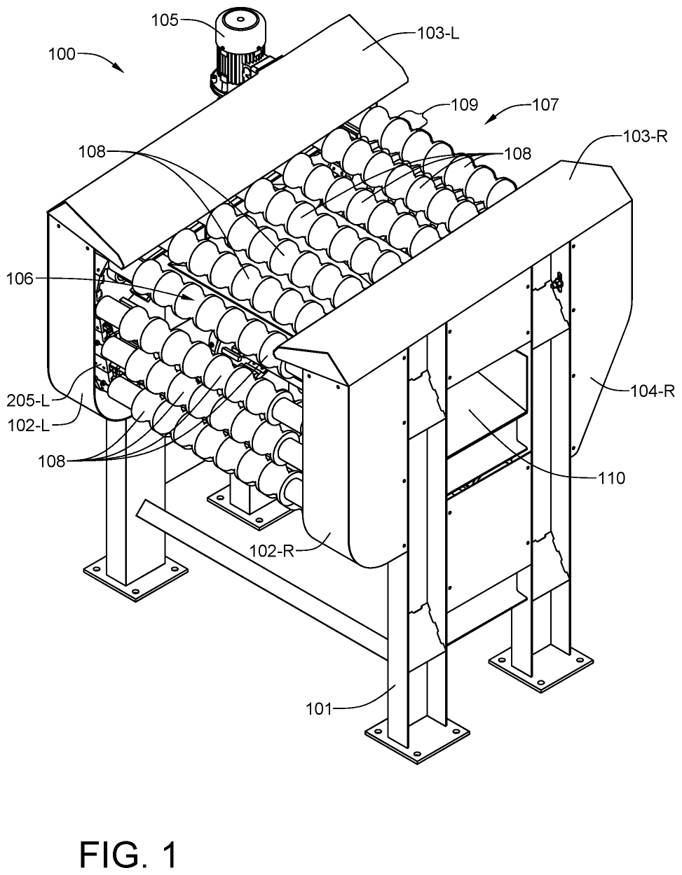

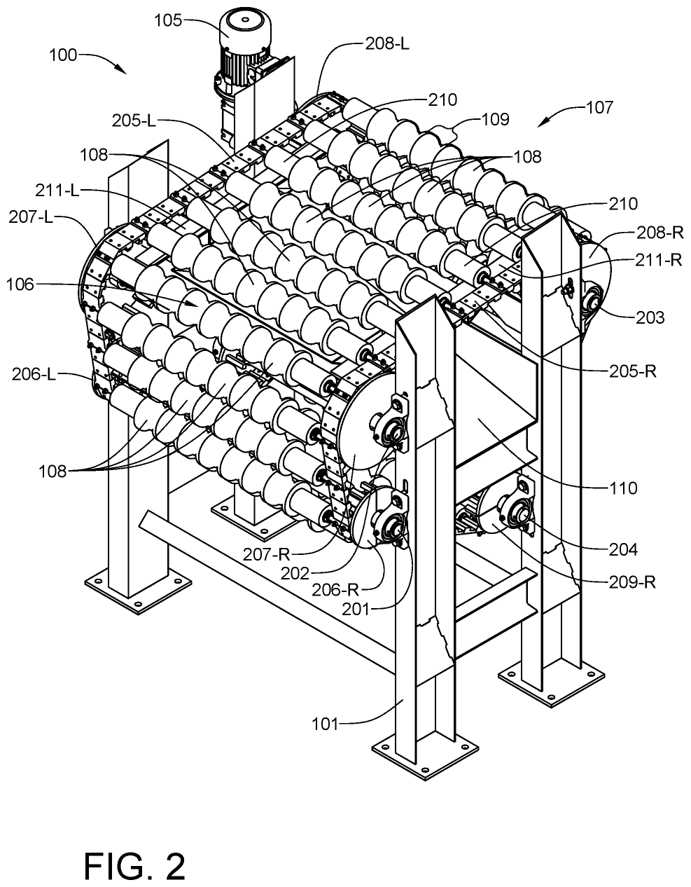

Referring now to FIGS. 1 and 2, the go/no-go produce sizer 100 of the present invention is designed to physically size tubers, fruit and vegetables that are generally spherical in shape. The sizer 100 can handle a wide range of product volume throughput, which is dependent on product density, piece count per volume, and equipment belt speed. The sizer 100 includes a frame 101 made of an austenitic stainless steel, such as No. 304 stainless steel. Austenitic steel alloys are non-magnetic stainless steels that contain high levels of chromium and nickel, but low levels of carbon. Known for their formability and resistance to corrosion, austenitic stainless steels are the most widely used grades of stainless steel, and have found particular use in the food processing industry. The go/no-go sizer 100 incorporates a conveyor bed made of rotating spindles 108, on which a plurality of identical spools 109, made from ultra-high-molecular-weight polyethylene (UHMWPE), are axially mounted end-to-end. Each spool has a flange at both ends. Spool flanges on adjacent spindles create pockets through which undersize generally spherical fruit or vegetables can fall onto an offload chute 110. Spools of varying sizes and shapes can be installed on the spindles, depending on the product being processed. It will be noted in FIGS. 1 and 2, that each spindle 108 is equipped with seven spools 109. That number can be smaller or larger, depending on product diameter. As spindles 108 move up the incline to the top of the sizer 100, rotational energy, as well as additional kinetic energy in a vertical direction, is imparted to them as opposite ends of each spindle move along elevated bump strips. This rotational and kinetic energy is transferred to the produce pieces after they are loaded onto the spindles 108 at a produce infeed end 106 of the sizer 100 at the bottom of the incline by a loader conveyor belt (not shown), travel up the incline, and either fall through the pockets created by spools on adjacent spindles 108, as undersize pieces of produce, or exit the discharge end 107 as oversize pieces of produce. It should be mentioned that the offload chute 110 can be replaced by an offloading conveyor (not shown), which can, potentially, feed another go/no-go sizer for additional product sizing. The undersize offloading conveyor can be placed near the spindles 108 at the top of the sizer 100 in order to minimize product drop.

Motivation for the rolling assembly of spindles 108 is provided by an electric motor 105 that is coupled to a head roller shaft 203 at the top of the incline. The motor is preferably an inverter duty rated gearmotor. As the name implies, the motor's speed is controlled by an inverter, or VFD (variable frequency drive). The difference between an inverter-duty gearmotor and a standard gearmotor is in the construction. These motors are specifically designed to operate at low speeds and not overheat. Because of the special way the windings are insulated, they are better able to withstand the voltage spikes of the fast-switching Pulse-Width-Modulated (PWM) signals generated by VFDs. The insulation will not break down and cause motor failure. Inverter-duty gearmotors produce a wider, constant-torque speed range than standard gearmotors.

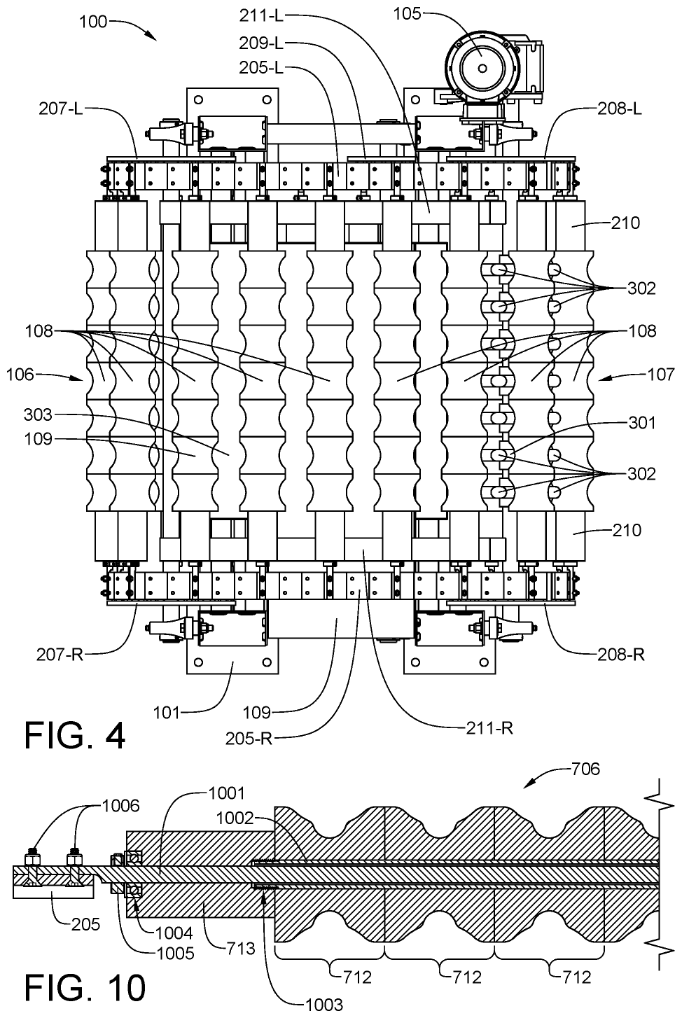

Opposite ends of each spindle 108 are secured to right and left cogged endless drive belts 205-R and 205-L, respectively. The spindles 108 are equidistantly spaced along the cogged drive belts 205-R and 205-L. Each cogged drive belt is wrapped around four toothed sprockets. The right cogged drive belt 205-R is wrapped around a first right takeup toothed sprocket 206-R, a right toothed tail sprocket 207-R, a right toothed head sprocket 208-R, and a second right toothed takeup sprocket 209-R. Likewise, the left cogged drive belt 205-L is wrapped around a first left takeup toothed sprocket 206-L, a left toothed tail sprocket 207-L, a left toothed head sprocket 208-L, and a second left toothed takeup sprocket 209-L (not shown in either FIG. 1 or 2, but visible in FIG. 4). The two first toothed takeup sprockets 206-R and 206-L are mounted on a first takeup roller shaft 201; the two toothed tail sprockets 207-R and 207-L are mounted on a tail roller shaft 202; the two toothed head sprockets 208-R and 208-L are mounted on the head roller shaft 203; and the two second toothed takeup sprockets 209-R and 209-L are mounted on a second takeup roller shaft 204. Looking at the go/no-go sizer from the right, or off-load chute side, both cogged drive belts 205-L and 205-R rotate in a clockwise direction, so that spindles 108 are constantly traveling up the incline during the sizing and sorting process.

Referring now specifically to FIG. 2, each end of each spindle 108 is equipped with a UHMWPE cylindrical roller 210. As the spindles 108 are moved by the cogged drive belts 205-R and 205-L, the cylindrical rollers 210 are dragged over bump strips 211-R and 211-L, respectively, causing the upper spindles of the sizer 100, which lie in a common inclined plane to rotate in a clockwise direction, as viewed from the right side of the sizer 100. The purpose of the inclined conveyor bed is to slow the transport of produce pieces from the in-feed end of the sizer 100 to the discharge end thereof, thereby providing individual undersize pieces with greater opportunity to fall through pockets in the bed. Of course, if the angle of inclination is too steep, little or no progress toward the discharge end will be made. Thus, there are two competing objectives that must be carefully balanced: produce throughput and adequate sorting of undersize and oversize pieces. An optimum angle of bed inclination will provide both an acceptable throughput and adequate sorting of pieces. An optimum angle of inclination is presently deemed to be between three and six degrees. Rotational speed of the spindles 108 can be varied by changing the diameter of the cylindrical rollers 210. The function of the bump strips 211-R and 211-L will be described in more detail with reference to FIGS. 4, 6, 7 and 9.

Referring now specifically to FIG. 1, guards are installed on the go/no-go sizer to protect operators from getting hands and clothing caught in the belts and drive system. A right front guard 102-R covers the right second toothed takeup sprocket 209-R, a front portion of the right cogged drive belt 205-R, and a portion of the right toothed tail sprocket 206-R, whereas a left front guard 102-L covers the left second toothed takeup sprocket 209-L, a front portion of the left cogged drive belt 205-L, and a portion of the left toothed tail sprocket 207-L. A right upper guard 103-R covers a portion of the right toothed tail sprocket 207-R, an upper portion of the right cogged drive belt 205-R, and a portion of the right toothed head sprocket 208-R, whereas a left upper guard 103-L covers a portion of the left toothed tail sprocket 206-L, an upper portion of the left cogged drive belt 205-L, and a portion of the left toothed head sprocket 207-L. Finally, a right rear guard 104-R covers a portion of the right toothed head sprocket 208-R, a rear portion of the right cogged drive belt 205-R, and the right first toothed takeup sprocket 206-R, whereas a left rear guard 104-L covers a portion of the left toothed head sprocket 208-L, a rear portion of the left cogged drive belt 205-L, and the left first toothed takeup sprocket 206-L. Although the left rear guard 104-L is not shown in any of the views, it is essentially a mirror image of the right rear guard 104-R.

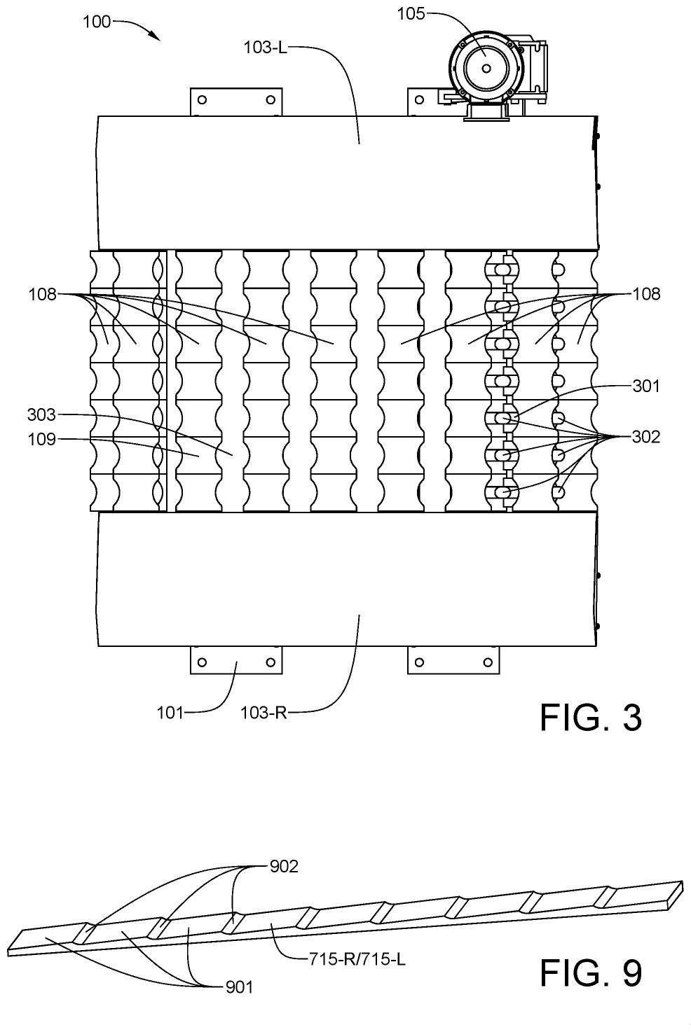

Referring now to FIGS. 3 and 4, there are seven spools 109 on each spindle 108 that are sandwiched between a pair of cylindrical rollers 210. The spools 109 and the cylindrical rollers 210 are all coaxially mounted on the spindle 108. As the cogged belts 205-R and 205-L transport the spindles 108, which lie in a common plane that forms the conveyor bed, up the incline to the discharge side of the sizer 100, the cylindrical rollers 210 are in contact with bump strips 401-R and 401-L, which are located on the right and left sides of the sizer 100, respectively. This contact causes all the spindles 108, which are in that common plane, to rotate in a clockwise direction, as seen from the right side of the sizer 100. As will be seen in FIG. 9, which depicts a bump strip which is similar, though longer than bump strips 401-R and 401-L, the bump strips have a series of upward ramps, each of which is followed by a near-vertical drop to the next upward ramp. Thus, the rotating spindles 108 impart rotational energy to the individual pieces of produce, while the bump strips impart kinetic energy to the individual pieces. Each ramp has a length within a range of 100 mm to 150 mm. Optimum ramp spacing depends on the spacing of the spindles 108 on the cogged drive belts 205-R and 205-L. Product pieces that are only slightly oversize can become intermittently lodged within sizing pockets. These pieces are ejected, or dislodged, from the sizing pockets by the fingers of a star wheel roller located on the head roller shaft 203, which push pieces stuck in pockets up and out so that they can drop off the conveyor bed at the discharge end 107 of the sizer 100 and onto an oversize produce collection chute or conveyor (neither of which are shown in this view), and pass into the product discharge as oversize pieces. The star wheel roller assembly 301 has a star wheel for each pocket which rotate so that individual fingers 302 on the star wheels project through the pockets to effect an ejection of produce pieces which are trapped in the pockets formed by spools 109 on adjacent spindles 108. In FIGS. 3 and 4, one spool 109 of seven spools placed end-to-end on each spindle is identified, as is a single pocket 303 formed by spools on adjacent spindles. Undersized produce pieces will fall through the pockets as the rolling assembly of spindles 108 climbs the incline to the discharge end 107 of the sizer 100.

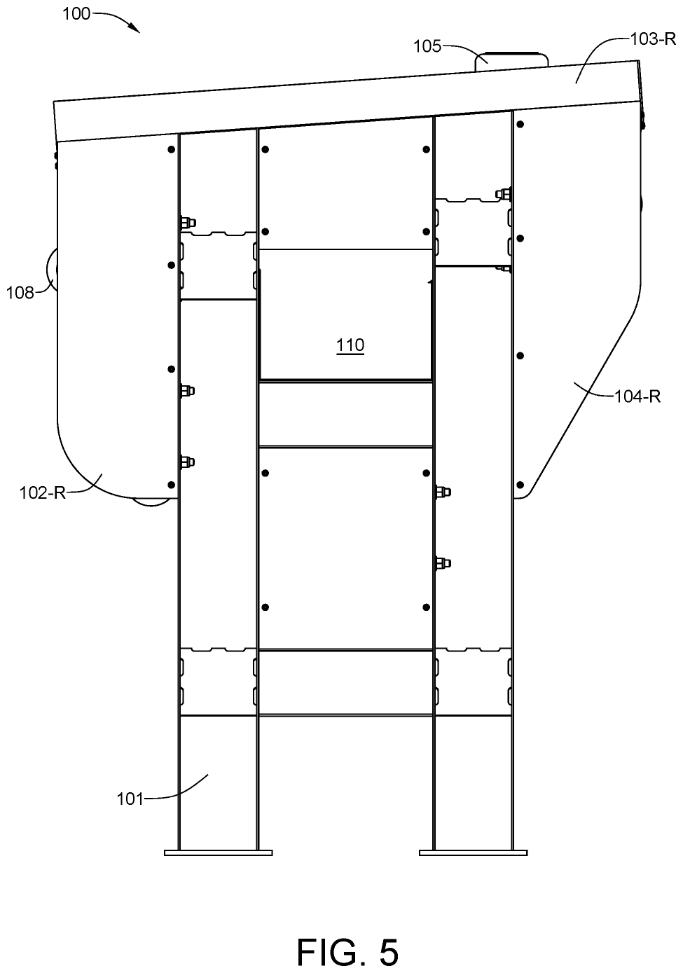

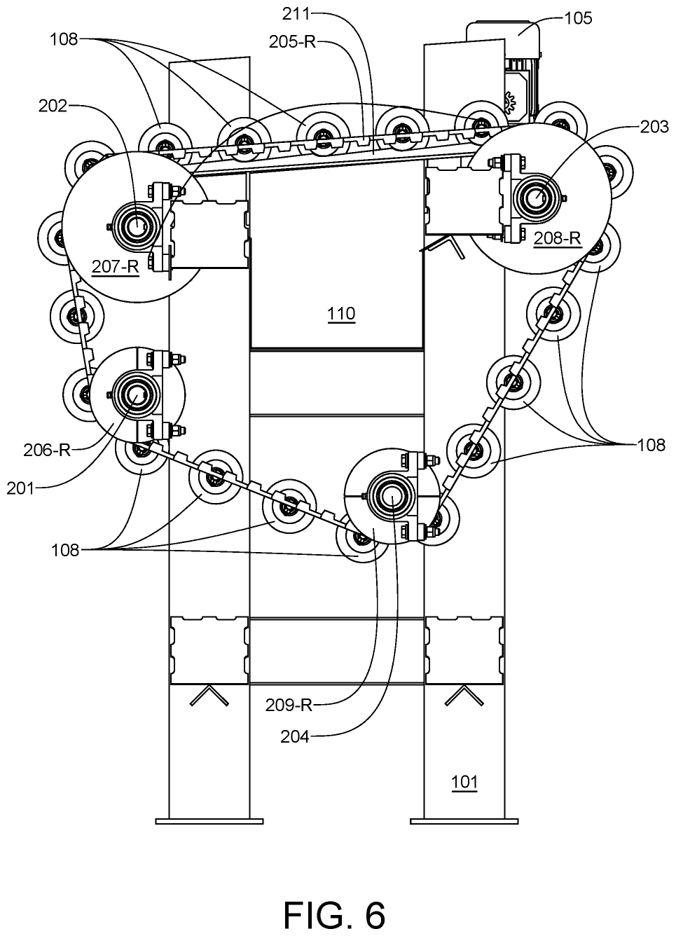

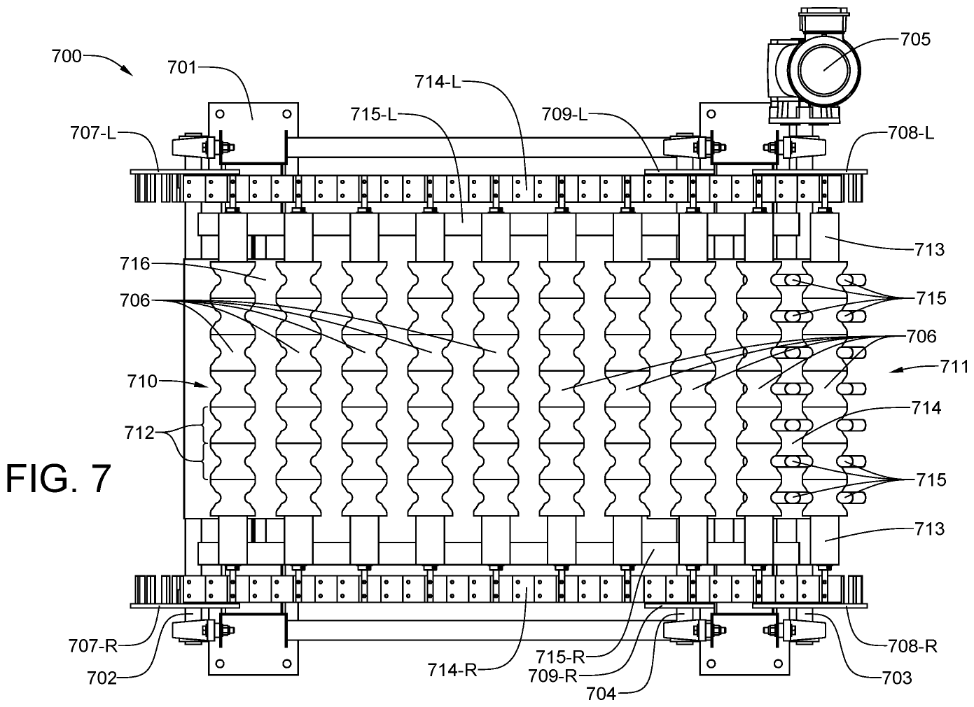

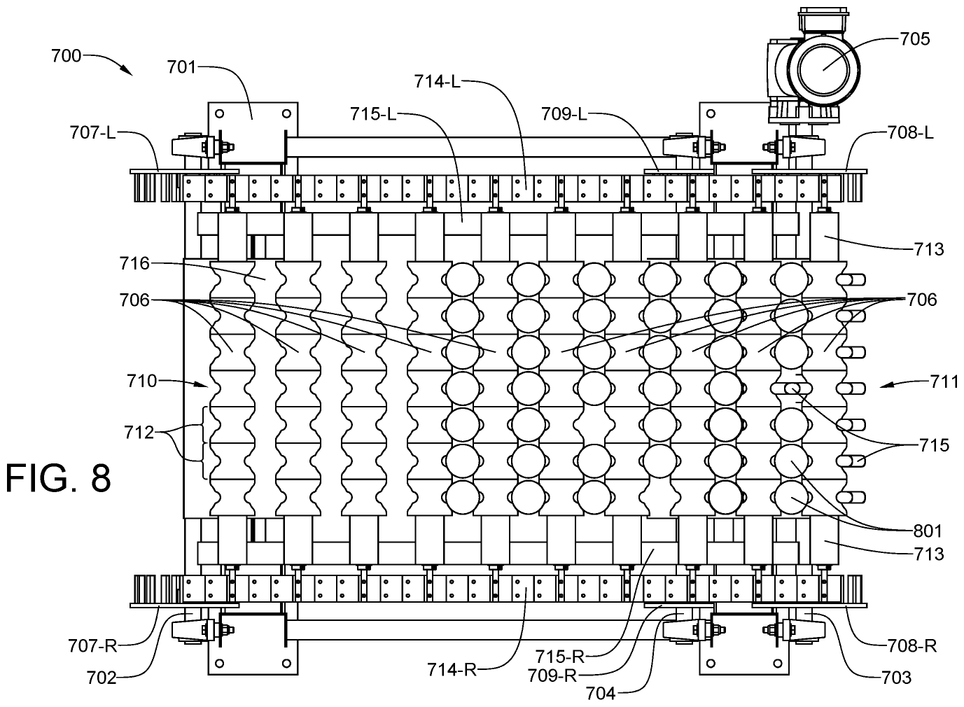

Referring now to FIG. 5, very little addition understanding of the go/no-go sizer 100 is provided by this drawing, other than providing a better look at the guards 102-R, 103-R and 104-R. However, with the guards of FIG. 5 removed, FIG. 6 provides a clear view of the entire track of the cogged drive belt 205-R. It should be noted that although portions of the belt 205-R and three spindles 108 which are attached to the belt 205-R behind the vertical portions of the frame 101 would not normally be visible, they are shown here in what is, essentially a see-through view. Although the side configuration of the right bump strip 401-R can be seen in this view, a better understanding of the structure of the bump strip 401-R can be obtained by reference to FIG. 9, which is actually a longer bump strip used on the sizer 700 of FIGS. 7 and 8.

Referring now to FIG. 7, an alternative embodiment go/no-go sizer 700 includes a frame 701 made of an austenitic stainless steel. The go/no-go sizer 700 also incorporates a conveyor bed of rolling spindles 706 at the top thereof that is considerably longer than that of the embodiment shown in FIGS. 1 through 6. Although the spools 712 are of a different shape and the spacing between the spindles 706 may not be the same as those of the sizer 100 of FIGS. 1 through 6, the basic function of the sizer 700 is the same as that for the sizer 100. The primary difference is that the longer rolling conveyor bed, which comprises ten spindles 706, as opposed to the seven of sizer 100, affords a greater produce throughput. It will be noted that two of the seven spools on a single spindle 706 have been identified as item 712. In addition, the cylindrical rollers 713 are identified as different part number from the cylindrical rollers 210 of the first embodiment sizer 100, as the two may not have the same diameter. Cylindrical rollers of different diameters can be used. As can be seen in FIG. 10, the rollers 713 are made of solid material, and there is no way to increase the diameter of an existing roller. Thus, the existing rollers must be replaced with replacement rollers having a different diameter. With no change in the travel speed of cogged belts 205-L/205-R or 714-L/714-R, the smaller the diameter of the rollers 210 or 713, the faster the spindles 108 or 706 will rotate. In FIGS. 7 and 8, the star wheel roller assembly 714 has been given a different item number, as different radial spacing of the fingers 715 will be different if the spacing (pitch) of the spindles on the drive belts is different. For a commercial-grade sizer, it is envisioned that the conveyor bed will be twice the width, with a corresponding increase in the number of spools per spindle. Like sizer 100, the alternative sizer 700 has an in-feed end 710 and a discharge end 711. The alternative sizer 700 also has a tail roller 702, a head roller 703 and a second takeup roller 704. It also has a first takeup roller which is not visible in this view. Right and left toothed tail sprockets 707-R and 707-L, respectively, are installed on the tail roller 702; right and left toothed tail sprockets 708-R and 708-L, respectively, are installed on the head roller 703; and right and left toothed second takeup sprockets 709-R and 709-L are installed on the second takeup roller 704. A right endless cogged drive belt 714-R wraps around the right toothed sprockets, while a left endless cogged drive belt 714-L wraps around the left toothed sprockets. It will be noted that sections of both drive belts on both sides of the bed have been removed so that the toothed tail sprockets 707-R and 707-L and the toothed head sprockets 708-R and 708-L are partially visible. The cylindrical rollers 713 ride on bump strips 715-R and 715-L. A an inverter duty rated gearmotor 705 powers the drive belts 714-R and 714-L. It will be noted that only one pocket 716 has been identified between spools 712 on adjacent spindles 706.

Referring now to FIG. 8, the sizer 700 of FIG. 7 has been loaded with generally spherical produce pieces 801. Forty produce pieces 801 are shown. A single finger 715 of the star wheel roller assembly 714 is visible in one of the pockets without a produce piece 801.

Referring now to FIG. 9, a stationary bump strip 708-R/708-L used in the go/no-go sizer 700 of FIGS. 7 and 8 is shown in detail. It will be noted that it includes a series of upward ramps 901, each of which is followed by a vertical drop 902 down to the next ramp, so that gravitational acceleration and sudden deceleration, or impact, are also imparted to each spindle multiple times as it travels across the bed.

Referring now to FIG. 10, half of a spindle 706 from the alternative sizer 700 of FIGS. 7 and 8 is shown in an enlarged view to better show details. The spindle 706 is an assembly comprising a central shaft 1001 preferably made of 0.50 inch (12.7 mm) diameter No. 304 stainless steel, a section of ½″ schedule 40 No. 304 stainless steel conduit 1002 having an inside diameter of 0.602 inches (about 15.3 mm), seven spools 712 made of UHMWPE that fit over the section of conduit 1002, a cylindrical roller 713 secured to each end of the section of conduit 1002 with a threaded connection 1003, a sealed stainless steel bearing assembly 1004 pressed into a recess in the outer end of each cylindrical roller 713, and a securable stainless steel collar 1005 adjacent each end of the central shaft 1001, both of which maintain prevent the threaded connections 1003 from loosening, and maintain the assembly of spools 712, cylindrical rollers 713 and section of conduit 1002 centered on the central shaft 1001. The threaded connections 1003 ensure that the spools 712 and cylindrical rollers 713 rotate as a solid unit. It will be noted that the central shaft 1001 is secured to the cogged endless belt 205 with a pair of threaded fasteners 1006.

Although only two embodiments of the go/no-go sizer for nominally spherical fruit, tubers and vegetables is shown and described, it will be obvious to those having ordinary skill in the art that changes and modifications may be made thereto without departing from the scope and the spirit of the invention as hereinafter claimed.

1. A go/no-go sizing device for separating generally spherical produce as a function of diameter, using both rotational and kinetic energy, said sizing device comprising:
a device frame constructed of stainless steel;
a tail roller, rotatably mounted on said device frame, said tail roller having right and left toothed tail sprockets, which are mounted at opposite ends thereof;
a head roller, rotatably mounted on said device frame, said head roller having right and left toothed head sprockets, which are mounted at opposite ends thereof;
a first take-up roller, rotatably mounted on said device frame, said first take-up roller having right and left toothed first take-up sprockets, which are mounted at opposite ends thereof;
a second take-up roller, rotatably mounted on said device frame, said second take-up roller having right and left toothed second take-up sprockets, which are mounted at opposite ends thereof;
wherein said tail roller, said head roller, said first take-up roller and said second take-up roller all have axes of rotation which are parallel to one another;
right and left, spaced-apart, cogged endless belts, said right cogged endless belt mounted on all four right toothed sprockets, and said left cogged endless belt mounted on all four left toothed sprockets, each belt traveling in a path around its associated sprockets when the rollers are rotated;
an electric motor coupled to one of the rollers which, when powered, causes each belt to travel in a path around the sprockets with which it is in contact, as the sprockets rotate on their respective rollers;
a plurality of spindles, each of which includes a central shaft on which are rotatably and coaxially mounted, end-to-end, a plurality of spools and two cylindrical rollers, with one roller being adjacent each end of the central shaft, a right end of each central shaft being secured to said right cogged belt, and a left end of each central shaft being secured to said left cogged belt, with each central shaft being perpendicular to both belts at its securing points;
wherein all spindles are evenly spaced along the right and left cogged belts so that pockets are formed between spools on adjacent spindles, said spindles forming a bed between said tail roller and said head roller, and said pockets being sized to permit only undersized produce pieces to fall through the bed for collection;
right and left stationary bump strips respectively positioned beneath and in contact with the cylindrical rollers coaxially mounted at the right and left ends of each central shaft, so that both rotational motion and impact following gravitational acceleration are imparted to each spindle multiple times as it travels across the bed; and
a star wheel roller having a plurality of fingers, which is located between the left and right sprockets of the head roller, said fingers ejecting any produce pieces which have become stuck in the pockets when they reach the discharge end of the bed.

2. The go/no-go sizing device of claim 1, wherein each spool and each cylindrical roller is formed from ultra-high-molecular-weight polyethylene.

3. The go/no-go sizing device of claim 1, wherein the bed is elevated from a produce in-feed end to a discharge end within a range of 3 to 6 degrees.

4. The go/no-go sizing device of claim 1, wherein each bump strip includes a series of upward ramps, each of which is followed by a vertical drop down to the next ramp.

5. The go/no-go sizing device of claim 1, wherein said electric motor is an inverter, duty rated gearmotor that is controlled by a variable frequency drive.

6. The go/no-go sizing device of claim 1, wherein the spools and cylindrical rollers on each spindle are axially secured to a tube to form a tube, spool and roller assembly, which fits over the central shaft and rotates around the central shaft on sealed ball bearing assemblies which are pressed into the outer end of each cylindrical roller.

7. The go/no-go sizing device of claim 1, wherein cylindrical rollers of different diameters can be employed to increase or decrease the rotational speed of spindles, and bump strips having ramps of various heights can be used to increase or decrease the vertical drop at the end of each ramp.

8. The go/no-go sizing device of claim 1, which further comprises a plurality of star wheel fingers located on the head roller, said star wheel fingers ejecting any produce pieces which have become stuck in the pockets when they reach the discharge end of the bed.

9. A go/no-go sizing device for separating generally spherical produce as a function of diameter, using both rotational and kinetic energy, said sizing device comprising:
a device frame constructed of stainless steel;
a tail roller, rotatably mounted on said device frame, said tail roller having right and left toothed tail sprockets, which are mounted at opposite ends thereof;
a head roller, rotatably mounted on said device frame, said head roller having right and left toothed head sprockets, which are mounted at opposite ends thereof;
a first take-up roller, rotatably mounted on said device frame, said first take-up roller having right and left toothed first take-up sprockets, which are mounted at opposite ends thereof;
a second take-up roller, rotatably mounted on said device frame, said second take-up roller having right and left toothed second take-up sprockets, which are mounted at opposite ends thereof;
wherein said tail roller, said head roller, said first take-up roller and said second take-up roller all have axes of rotation which are parallel to one another;
right and left, spaced-apart, cogged endless belts, said right cogged endless belt mounted on all four right toothed sprockets, and said left cogged endless belt mounted on all four left toothed sprockets, each belt traveling in a path around its associated sprockets when the rollers are rotated;
an electric motor coupled to one of the rollers which, when powered, causes each belt to travel in a path around the sprockets with which it is in contact, as the sprockets rotate on their respective rollers;
a plurality of spindles, each of which includes a central shaft on which are rotatably and coaxially mounted, end-to-end, a plurality of spools and two cylindrical rollers, with one roller being adjacent each end of the central shaft, a right end of each central shaft being secured to said right cogged belt, and a left end of each central shaft being secured to said left cogged belt, with each central shaft being perpendicular to both belts at its securing points;
wherein all spindles are evenly spaced along the right and left cogged belts so that pockets are formed between spools on adjacent spindles, said spindles forming a bed between said tail roller and said head roller, and said pockets being sized to permit only undersized produce pieces to fall through the bed for collection;
and
a star wheel roller having a plurality of fingers, which is located between the left and right sprockets of the head roller, said fingers ejecting any produce pieces which have become stuck in the pockets when they reach the discharge end of the bed.

10. The go/no-go sizing device of claim 9, wherein each spool and each cylindrical roller is formed from ultra-high-molecular-weight polyethylene.

11. The go/no-go sizing device of claim 9, wherein the bed is elevated from a produce in-feed end to a discharge end within a range of 3 to 6 degrees.

12. The go/no-go sizing device of claim 9, wherein said electric motor is an inverter, duty rated gearmotor that is controlled by a variable frequency drive.

13. The go/no-go sizing device of claim 9, wherein the spools and cylindrical rollers on each spindle are axially secured to a tube to form a tube, spool and roller assembly, which fits over the central shaft and rotates around the central shaft on sealed ball bearing assemblies which are pressed into the outer end of each cylindrical roller.

14. The go/no-go sizing device of claim 9, wherein cylindrical rollers of different diameters can be employed to increase or decrease the rotational speed of spindles, and bump strips having ramps of various heights can be used to increase or decrease the vertical drop at the end of each ramp.

15. The go/no-go sizing device of claim 9, wherein each of the stationary strips includes a series of upward ramps, each of which is followed by a vertical drop down to the next ramp, so that vertical motion is also imparted to each spindle as it travels across the bed.

16. A go/no-go sizing device for separating generally spherical produce as a function of diameter, using both rotational and kinetic energy, said sizing device comprising:
an endless conveyor bed of rotating spindles on which multiple spools are axially mounted end-to-end so that pockets are formed between axially-aligned spools on adjacent spindles, said pockets sized to permit undersized produce pieces to fall through the bed, wherein each of said rotating spindles has a cylindrical roller at each end thereof that can be interchanged with others having different diameters in order to increase or decrease rotational speed of the spindles, each cylindrical roller being in contact with a stationary bump strip, which includes a series of upward ramps, each of which is followed by a vertical drop down to the next ramp, so that both rotational motion and vertical motion are imparted to each spindle as it travels across the bed; and
a star wheel roller having a plurality of fingers that is located on a head roller shaft that is adjacent a discharge end of the endless conveyor bed, said fingers ejecting any produce pieces which have become stuck in the pockets when they reach the discharge end of the endless conveyor bed.

17. The go/no-go sizer device of claim 16, wherein the conveyor bed is elevated from an infeed end of the bed to a discharge end of the bed within a range of 3 to 6 degrees.

18. The go/no-go sizing device of claim 16, wherein each spool is formed from ultra-high-molecular-weight polyethylene.

19. The go/no-go sizing device of claim 16, wherein said conveyor bed is powered by an inverter, duty rated gearmotor that is controlled by a variable frequency drive.

20. The go/no-go sizing device of claim 16, wherein the endless conveyor bed is suspended between a tail roller and a head roller, said head roller having installed thereon a plurality of star wheel fingers, said star wheel fingers ejecting any produce pieces which have become stuck in the pockets when they reach the discharge end of the bed.
